(19) United States
(12) Patent Application Publication
(10) Pub. No.: US 2026/0059629 A1
(43) Pub. Date: Feb. 26, 2026

(54) WIND CHIMES WITH SOUND-ACTIVATED LIGHTING ELEMENTS

(71) Applicant: Evergreen Enterprises, Richmond, VA (US)

(72) Inventor: James XU, Richmond, VA (US)

(21) Appl. No.: 18/815,381

(22) Filed: Aug. 26, 2024

(51) Int. Cl. H05B 47/12; G10K 1/10; H04R 1/02; H05B 47/16

(52) U.S. Cl. CPC H05B 47/12; G10K 1/10; H04R 1/028; H05B 47/16

(57) ABSTRACT

A wind-driven sound and light device has at least one resonant element, a striker configured to strike the at least one resonant element in response to wind, thereby producing a ringing event. A lighting element comprising an illuminator is associated with each resonant element. The device also has a power source, a ring event sensor, and an illumination processing system. The ring event sensor produces a data signal in response to a ring effect The illumination processing system is configured to receive the data signal from the ring event sensor and, in response to the data signal, cause the circuit arrangement to activate the illuminator of at least one of the at least one lighting element by connecting it to the power source.

### BACKGROUND OF THE INVENTION

The invention relates generally to wind chimes and, more particularly, to devices having illumination features that coordinate a light display with sounds produced by a wind-activated percussive instrument.

It has long been known that wind movement can be used to produce distinct musical tones. In many instances, this is accomplished through the use of percussive devices comprising a suspended or fixed resonant body that is configured to be struck by a suspended mass or pendulum (referred to herein as a striker) when wind causes relative motion between the two.

Such devices are referred to herein as wind chime devices or simply, wind chimes.

A wind chime device may have a single resonant body to produce a single tone or multiple resonant bodies with geometric or material variations that produce different tones.

Chimes are often configured to provide a series of musically related tones that produce a random melody when subjected to a breeze. They are also often configured to provide a pleasing decorative appearance in addition to a pleasing sound.

### SUMMARY OF THE INVENTION

An illustrative aspect of the invention provides a wind-driven sound and light device comprising at least one resonant element configured to produce a ringing sound when struck.

The sound and light device further comprises a striker configured and positioned to strike at least one of the at least one resonant element in response to ambient air motion, thereby producing a ringing event. The device still further comprises at least one lighting element comprising an illuminator. Each of the at least one lighting element is associated with one of the at least one resonant element. The device also comprises a power source, a ring event sensor, and an illumination processing system. The ring event sensor is configured to produce and transmit a data signal in response to a ring effect produced by the ringing event. The illumination processing system is in communication with the ring event sensor and a circuit arrangement comprising the power source and each of the at least one lighting element. The illumination processing system is configured to receive the data signal from the ring event sensor and, in response to the data signal, cause the circuit arrangement to activate the illuminator of at least one of the at least one lighting element by connecting it to the power source.

Another illustrative aspect of the invention provides a wind-driven sound and light device comprising at least one resonant element configured to produce a ringing sound when struck. The sound and light device further comprises a striker configured and positioned to strike at least one of the at least one resonant element in response to ambient air motion, thereby producing a ringing event. The device still further comprises at least one lighting element comprising an illuminator. Each of the at least one lighting element is associated with one of the at least one resonant element. The device also comprises a power source, an acoustic sensor, and an illumination processing system. The acoustic sensor is configured and positioned to receive sound waves produced by the ringing event, transform the soundwaves into an analog signal, and transmit the analog signal. The illumination processing system is in communication with the acoustic sensor and a circuit arrangement comprising the power source and each of the at least one lighting element. The illumination processing system is configured to receive the analog signal for the ringing event from the acoustic sensor, convert the analog signal to a digital signal, determine from the digital signal whether illumination criteria have been met, and, responsive to a determination that illumination criteria have been met, cause the circuit arrangement to activate the illuminator of at least one of the at least one lighting element by connecting it to the power source.

Another illustrative aspect of the invention provides a wind-driven sound and light device comprising a suspension body, a plurality of tubular chimes, a striker, and a plurality of lighting elements. The suspension body comprises a housing having a housing wall defining an interior space. The plurality of tubular chimes are suspended vertically lengthwise from the suspension body by chime strands. Each tubular chime is sized and configured to produce a ringing sound with different sound characteristics when struck. The striker is suspended from the suspension body by a non-conductive main strand and is configured and positioned to strike one or more of the resonant elements as the result of a swinging motion produced by ambient air motion. Each strike of a resonant element produces a ringing event. Each lighting element is associated with one of the resonant elements and has an illuminator. The sound and light device further comprises a power source disposed within the interior space and an illumination circuit arrangement configured for selectively connecting each lighting element to the power source to activate the illuminator of each said lighting element. The sound and light device still further comprises an acoustic sensor and an illumination processing system. The acoustic sensor is configured and positioned to receive sound waves produced by ringing events, transform the soundwaves into analog signals, and transmit the analog signals. The illumination processing system is disposed within the interior space of the housing and is in communication with the acoustic sensor and the circuit arrangement. The illumination processing system is configured to receive and process signals received from the acoustic sensor and to cause the circuit arrangement to activate one or more illuminators in response to the processed signals.

### BRIEF DESCRIPTION OF THE DRAWINGS

The invention can be more fully understood by reading the following detailed description together with the accompanying drawing, in which like reference indicators are used to designate like elements, and in which:

FIG. 1 is a perspective view of a wind-driven sound and light device according to an embodiment of the invention;

FIG. 2 is a partially sectioned side view of the wind-driven sound and light device of FIG. 1;

FIG. 3 is a section view of a lighting element of a wind-driven sound and light device according to an embodiment of the invention;

FIG. 4 is a section view of a suspension body of a wind-driven sound and light device according to an embodiment of the invention; and

FIG. 5 is a schematic representation of a lighting control system of a wind-driven sound and light device according to an embodiment of the invention.

FIG. 6 is a section view of a suspension body of a wind-driven sound and light device according to an embodiment of the invention; and

FIG. 7 is a schematic representation of a lighting control system of a wind-driven sound and light device according to an embodiment of the invention.

### DETAILED DESCRIPTION OF THE INVENTION

Embodiments of the present invention provide an additional element to traditional wind chimes in that they include lights that illuminate in response to the sound produced when a resonant element is struck.

It has been known in the prior art to include contact-responsive lighting elements in wind chime devices. See, e.g., U.S. Pat. No. 4,854,214 (Lowe) and U.S. Pat. No. 10,062,365 (Finigan). These devices, however, depend on the completion of an electrical circuit when a conductive resonant body is contacted by a conductive striker. The completion of this circuit may trigger a switch that results in the illumination of a light associated with the resonant body.

In contrast, the devices of the present invention have circuitry that includes one or more sensors/processors that react to the sound produced by striker-to-resonant device contact.

Upon sensing the occurrence of this sound, the circuitry may cause a lighting element to illuminate. In various embodiments, the response of the circuitry is so fast that, to an observer, the sound and the illumination may appear to be simultaneous.

While the present invention will be described primarily with reference to wind chime devices having multiple tubular chimes and a single striker, all suspended from an overhead support body, it will be understood that the invention may be incorporated into any form of wind-activated instrument including, without limitation, other single or multiple suspended chimes having solid or tubular resonant bodies, chimes having fixed bars or other resonant elements with wind-blown strikers, and chimes or bells having internal strikers (generally referred to as clappers).

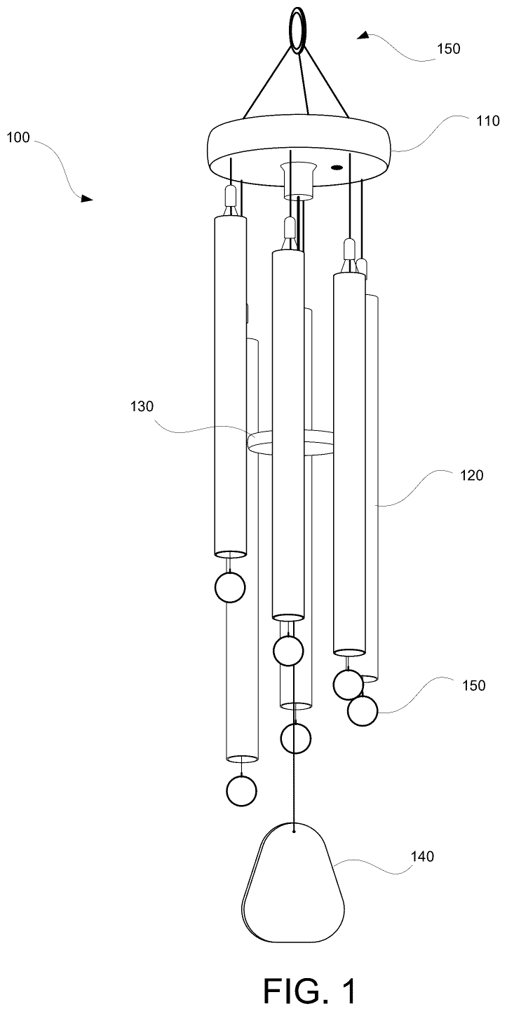

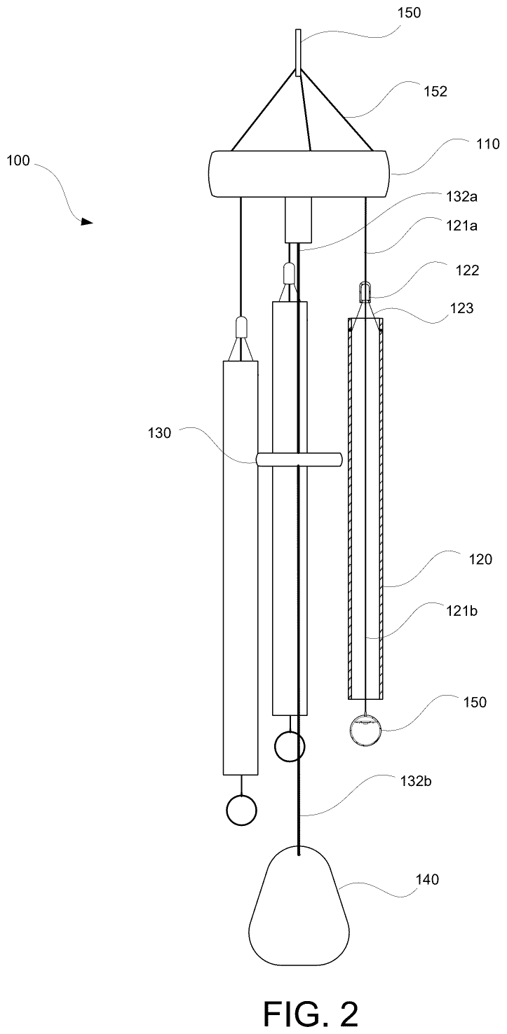

With reference now to FIGS. 1 and 2, a wind-driven sound and light device 100 according to an illustrative embodiment of the invention includes a suspension body 110, a plurality of tubular resonant elements 120, a striker 130, and a sail 140. As in typical wind chime devices, the resonant elements 120 are suspended from the suspension body 110, which, in turn is suspended from a hanger arrangement 150. Each resonant element 120 is suspended from the suspension body 110 by a primary chime strand 121a, a hanger body 122 attached to the primary chime strand 121a and one or more secondary chime strands 123 attached to the hanger body 122 and the resonant element 120. The various support strands are configured to provide support to the resonant element 120 while minimizing effects on the tones produced by the resonant element when struck.

The striker 130 and sail 140 are also suspended from the suspension body 110. The striker 130 is configured and suspended in a manner so that wind-driven movement of the sail 140 causes the striker 130 to swing, which results in occasional and random contact with the individual resonant elements 120. Such contact may cause the contacted element 120 to produce a resonant tone (referred to herein as a “ringing tone” or a “ring”). While in the illustrated embodiment, the striker 130 is formed as a solid circular disk, the striker 130 may be any regular or irregular geometric shape and may be hollow. It may also be monolithic, composite, or multi-structural. The striker 130 may be formed from any material, including but not limited to wood, plastic, metal, stone, or ceramic.

The striker 130 is suspended from the suspension body 110 by a first main strand 132a and the sail 140 is suspended from the striker 130 by a second main strand 132b. In some embodiments, the first and second main strands 132a and 132b are portions of a single main strand that passes through the striker 130, which is attached thereto. The sail 140 is typically formed as a generally planar member that may have any desired geometric shape. It is typically sized so as to provide a desired motion in response to air movement, thereby producing lateral movement of the striker 130 to contact one or more resonant elements 120.

Each resonant element 120 and its corresponding primary and secondary chime strands 121a, 123 may be sized configured to produce particular resonant tones. The pitch and other sound characteristics of the resonant elements 120 may be varied, in particular, based on material (e.g., wood, metal, ceramic, etc.), wall thickness, and internal and external dimensions. When multiple resonant elements 120 are used, resonant element geometry and strand length may be varied to provide particular tone combinations as desired.

It will be understood that a ring event produced by the striker 130 and a resonant element produce certain detectable effects within and around the striker 130 and resonant element 120. Suh effects may include, without limitation, sound waves in the air around the wind chime device, vibration within either or both of the striker 130 and resonant element 120, and deformation and/or strain changes in the structure of the striker 130 and resonant element 120. As will be discussed in more detail hereafter, detection of these effects and their characteristics can be used to identify and characterize ring events.

The sound and light device 100 also has a plurality of lighting elements 150, with one such element 150 associated with each of the resonant elements 120. In the illustrative embodiment of FIG. 1, each lighting element 150 comprises a hollow spherical body 151 suspended from the hanger body 122 by a lighting element strand 121b. In this embodiment, the lighting element strand 121b and the primary chime strand 121a are lower and upper portions of a single strand to which the hanger body 122 is attached. In some embodiments, however, the lighting element strand 121b may be a separate strand attached to and suspended from the hanger body 122. As will be discussed in more detail hereafter, the strand portions 121a and 121b may be or include a conductive element to provide electrical communication between the lighting element 150 and circuitry housed within the suspension body 110.

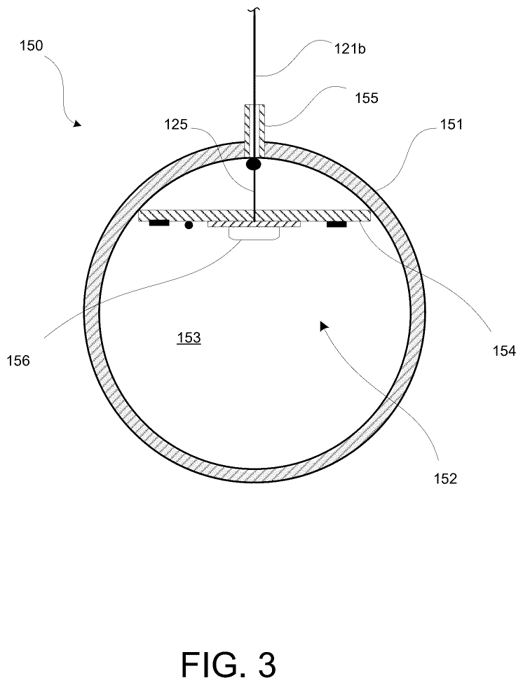

With reference to FIG. 3, the lighting element 150 has a hollow body 151 formed from a light transmissive material such as glass or plastic. The material may have a color tint or may be neutral so that light passing therethrough retains a pre-established color appearance.

While in the illustrated embodiment, the lighting element body 151 is a hollow sphere, it will be understood that any regular or irregular geometric shape may be used.

The lighting element body 151 defines an interior space 153 in which is mounted an illuminator assembly 152. In the illustrated embodiment, the illuminator assembly 152 includes a circuit board 154 and a solid state illuminator 156 (e.g., a light emitting diode (LED) and associated circuity. It will be understood that other illuminator mechanisms can be used, including any form of incandescent light socket/bulb. The body 151 may include a support stem 155 surrounding a passage through the body wall into the interior space 153. The passage is sized and configured to receive the distal end of the lighting element strand 121b, the conductor portion of which is electrically connected to the illuminator assembly 152. The lighting element strand 121b is also structurally connected to either or both of the lighting element body 151 and the circuit board 154 so that the entire lighting element 150 may be suspended from the suspension body 110. In the illustrated embodiment, the lighting element strand 121b is attached to the hanger body 122 and passes through the center of the resonant element 120 so that the lighting element 150 is suspended just below the resonant element 150.

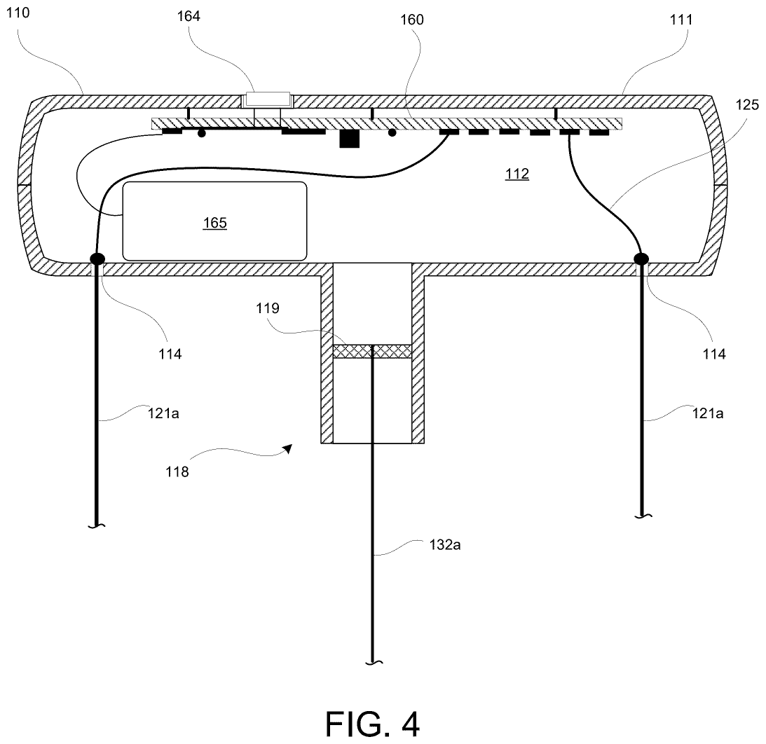

The suspension body 110 is configured to provide a support from which the other elements of the device 100 are suspended and to provide a housing for the circuitry and processing system used to control activation of the lighting elements 150. With reference to FIG. 4, the suspension body 110 has a case wall 111 defining an interior space 112. Holes 114 through the case wall 111 are provided for passage and retention of the primary chime strands 121a. Also mounted within the interior space 112 are one or more circuitry boards 160 and a power source 165 (e.g., a battery or converted AC power supply). In some embodiments, an activation switch (e.g., a mechanical or pressure activated button) 164 in electrical communication with the circuitry board(s) 160 may be provided.

The suspension body 110 may be any shape, but is typically formed in a disc shape as in the illustrated embodiment. In the sound and light device 100, the suspension body includes an anchoring extension 118 extending downward from the center of the suspension body 110.

The anchoring extension 118 is configured to receive the proximal end of the first main strand 132a, which is attached to an anchor member 119 central includes a first main strand 132a. The anchoring extension 118 and anchor member 119 may be configured to provide a range of freedom of swing motion for the striker 130 and the sail 140.

As previously noted, the primary chimes strands 121a and lighting element strands 121b are or include electrically conductive elements. Accordingly, each strand 121a provides a dual purpose of supporting a resonant element 120 and its associated lighting element 150 and, in combination with its respective lighting element strand 121b, providing electrical communication between the lighting element 150 and the circuitry board 160. In the illustrated embodiment, the primary chime strand 121a and lighting element strand 121b for each resonant element 120 includes a conductor 125 that is connected at one end to the illuminator assembly 152 of the lighting element 150 and at the other end to the circuit board 160. In some embodiments, the conductor 125 may be a single, continuous wire strand. In other embodiments, the conductor may be made up of multiple wire strands directly or indirectly connected to one another.

It will be understood that embodiments of the invention are not confined to the arrangement shown in FIGS. 1-4. For example, in some embodiments, the lighting elements 150 could be suspended above the resonant elements 120. In other embodiments, multiple lighting elements could be associated with each resonant element. In some cases, some or all of such lighting elements could be fixedly attached to the resonant elements 120.

It will also be understood that the arrangement of the resonant elements and the illuminators may be dependent on the type of wind chime device.

In various embodiments of the invention, the circuitry components housed in the suspension body 110 are or include a lighting control system generally configured for receiving and processing signals from one or more sensors that detect an effect produced by contact between the striker 130 and one of the resonant elements 120. In response to such identifying a ring event, power from the power source 165 may be routed to one or more of the lighting elements 150, thereby activating the illuminator assembly 152.

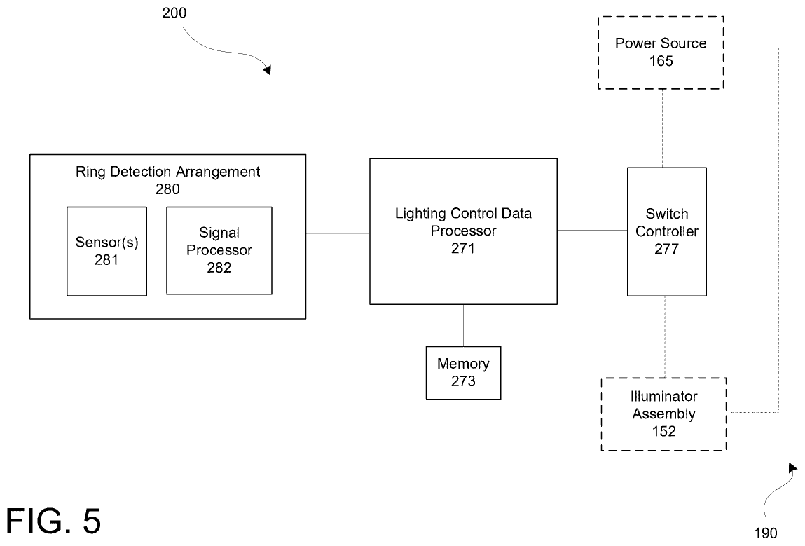

FIG. 5 schematically illustrates a lighting control system 200 according to an embodiment of the invention that includes a ring detection arrangement 280, a lighting control data processor 271, and a switch controller 277 configured for selectively completing an illumination circuit 190 comprising the power source 165 and one or more of the illuminator assemblies 152. Any or all of the components of the ring detection arrangement 280, the lighting control data processor 271, and the switch controller 277 may be mounted to a circuit board (e.g., circuit board 160) within the suspension body 110 as shown in FIG. 4.

The ring detection arrangement 280 may include one or more sensors 281 configured to produce and transmit a data signal in response to an effect produced by a ring event. As previously discussed, such effects may include sound waves, structural vibrations of the striker 130 or resonant element 120. The sensor(s) 281 may be or include any sensing element capable of detecting one of these effects and producing a data signal in response thereto. Typical sensors may include, for example, acoustic sensors and surface-mounted accelerometers, strain gages or vibration detectors.

In some embodiments, each individual sensor 281 may be associated with a single resonant element 120 so that it detects only an effect produced by that element 120. In other embodiments, the one or more sensors 281 may be chosen or configured to detect an effect produced by any of the resonant elements 120. In such embodiments, each sensor 281 may be configured to measure characteristics of a detected ring effect so that the particular element 120 producing the effect can be identified. Such characteristics could include for example sound wave or vibration amplitude or frequency. Placement of the sensors 281 may depend on the type of sensor and the ring effect being measured. For example, an acoustic sensor may be positioned anywhere within a sound detection radius of the resonant elements 120. This could be in or on the suspension body 110 or the hanging arrangement above the suspension body 110. It could also be in a separate unit attached to a wall or other structure from which the wind chime device 100 is suspended. Vibration sensors or accelerometers could be attached to the surface of the resonant elements 120 or to the hanger bodies 122 or strands 121a from which the resonant elements 120 are suspended. In some embodiments, a vibration sensor or accelerometer may be attached to the striker 130. In these embodiments, every contact between the striker 130 and any of the resonant elements 120 could be detected by a single sensor 281.

The ring detection arrangement 280 may also include one or more signal processors 482 in communication with the one or more sensors 281. The signal processor 482 may be configured to receive the data signal from the sensor(s) 281, convert it to digital format, and transmit it to the lighting control data processor 271. The lighting control data processor 271 is configured to receive sound event information (e.g., sound wave or vibration frequency) from the signal processor 482 and compare it to criteria used to determine if one or more lighting elements 150 should be illuminated. Such criteria may be permanently stored in a memory 273 for retrieval by the data processor 271. In some embodiments, different criteria options may be made selectable by a user. In some embodiments, a user interface (not shown) in the form of a keypad, switch or button panel may be used to obtain selections from the user.

The lighting control data processor 271 may be further configured to, upon determining that illumination criteria have been met, identify an action to be taken in response. This can include an action for a specific lighting element 150 to be illuminated for a predetermined duration, an action for a random lighting element 150 to be illuminated for a predetermined duration, or for a sequence of one or more lighting elements 150 to be illuminated. Such actions may be accomplished by issuing switch commands to the switch controller 277. The switch controller 277 is configured to open and close a plurality of circuits 190, each of which connects a different illuminator assembly 152 to the power source 165. Upon receiving an illumination command from the lighting control data processor 271, the switch controller 277 closes the circuit for a specified illuminator assembly 152. Upon receiving a command to terminate illumination, the switch controller 277 re-opens the circuit.

The lighting control data processor 271 may also be configured to control the illumination characteristics of lighting elements with variable lighting capability. For example, some illuminator assemblies 152 may have the capability of changing the color of emitted light. The lighting control data processor 271 may be configured to send commands to such illuminator assemblies 152 based on the occurrence of pre-programmed criteria or upon receiving instructions from the user.

In particular embodiments, the lighting control data processor 271 may be configured to compare the characteristics derived from received ring event data to expected sound characteristics for the resonant elements 120 of a wind-driven sound and light device 100. If the event characteristics match (within predetermined limits) expected event characteristics for a particular one of the resonant elements 120, the lighting control data processor 271 may cause the lighting element 150 associated with that particular resonant element 120 to be illuminated.

From the above, it can be seen that in wind chime devices according to the invention, the ringing of a particular resonant element can be used to initiate illumination of one or more lighting elements directly associated with that resonant element, Further, the response of the sensors and the speed of the processors used in the system 200 may be such that, to an observer, the illumination of the lighting element (or initiation of a lighting sequence) is nearly simultaneous with the sound of the ring. A sequence of sound events resulting from the sequential ringing of multiple resonant elements will produce a corresponding illumination sequence of the lighting elements associated with the resonant elements. It has been found, however, that to a typical observer, it may not matter that a specific lighting element associated with a particular chime is illuminated when that chime is struck, so long as one of the lighting elements is illuminated. Accordingly, in some embodiments, any lighting element may be randomly selected for illumination upon occurrence of a sound event associated with the ringing of any of the resonant elements. This eliminates the need to analyze a sound event to determine which resonant element is the source of the event. This, in turn, reduces the processing required to analyze the event and increases the speed with which the system responds to the event.

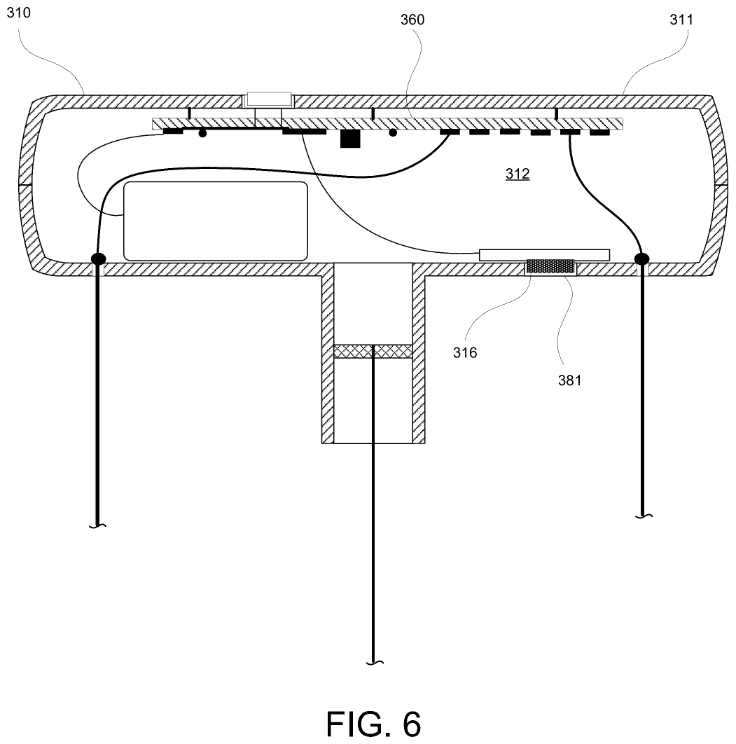

In particularly suitable embodiments of the invention, acoustic sensors may be used to detect ring events. In a particular embodiment illustrated in FIG. 6, a suspension body 310 has features similar to those of suspension body 110 of FIGS. 1 and 4. These features include a case wall 311 defining an interior space 312 within which a circuit board 360 is disposed. In this embodiment, an aperture 316 is formed through a downward facing portion of the case wall 311 for receiving an acoustic sensor 381. While a single aperture 316 and sensor 381 are shown, it will be understood that multiple sensors 381 may be similarly provided, with each such sensor being in electrical communication with the circuitry of the board 360. The one or more acoustic sensors 381 are configured and positioned so as to detect sound waves emanating from ring events produced by striker and resonant elements suspended from the suspension body 310.

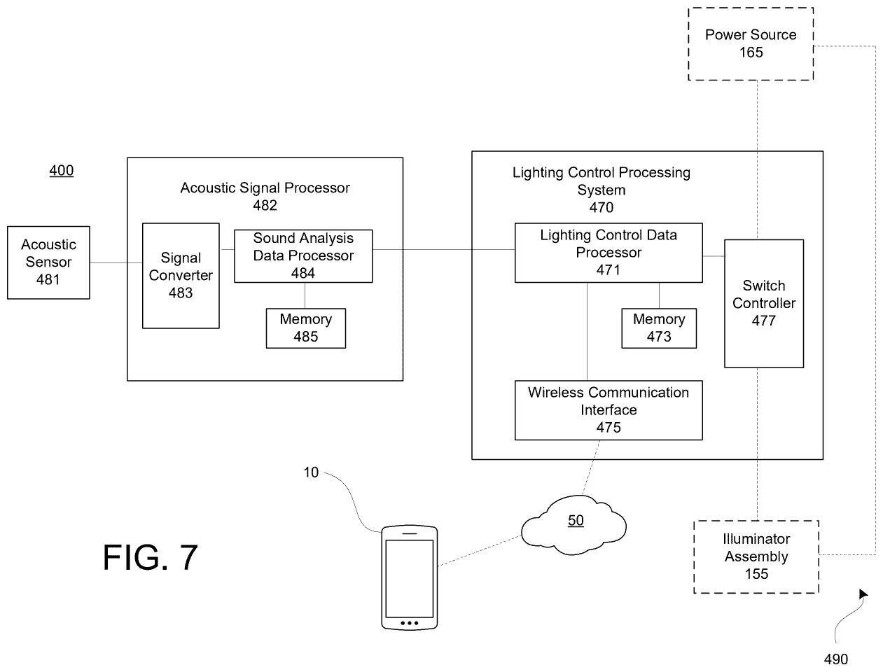

FIG. 7 schematically illustrates an illumination processing system 400 according to an embodiment of the invention that can be used in conjunction with, inter alia, the wind-driven sound and light device 100 of FIGS. 1-3. The illumination processing system 400 includes one or more acoustic sensors 481, an acoustic signal processor 482, a lighting control processing system 470 in communication with the acoustic signal processor 482, and a lighting circuit 490 for selectively connecting the power source 165 to one or more illuminator assemblies 152. Any or all of the acoustic sensor(s) 481, acoustic signal processor 482, and lighting control processing system 470 may be mounted to the circuit board 160 within the suspension body 110.

The acoustic sensor 481 may be any sensor configured to convert sound waves into electrical signals. Sound is a form of mechanical energy that travels through a medium (e.g., air, water, or solid materials) in the form of waves. When an object such as the resonant elements are struck and/or vibrate, they generate a series of compressions and rarefactions in the surrounding medium, which constitute sound waves. Acoustic sensors, also known as microphones or sound sensors, typically work by detecting variations in air pressure caused by sound waves and transform them into electrical signals that can be further processed, stored, or transmitted. The electrical signal generated by the acoustic sensor is typically very weak and may need to be amplified before further processing. After amplification, the analog electrical signal may be converted into a digital format using an analog-to-digital converter (ADC). The digital signal allows for easier processing, storage, and transmission using digital devices and computer systems.

Accordingly, the acoustic sensor 481 is configured to receive sound waves, convert them to an analog electrical signal and transmit them to the acoustic signal processor 482 via a signal amplifier 467. The acoustic signal processor 482 includes a signal converter 483 that receives the amplified signal from the acoustic sensor 481 and converts it to digital format for analysis. The acoustic signal processor 482 further includes a sound analysis data processor 484 and an associated memory 485. The sound analysis processor 481284 is configured to process the digitized sound data to establish the occurrence of a sound event and to determine the sound characteristics of that event. Such characteristics may include, for example, frequency, wavelength, and amplitude. The sound analysis data processor 484 may also be configured to carry out filtering or isolation using known processing methods. In some embodiments, the sound analysis processor 484 may require a minimum volume threshold for processing and/or further transmitting digitized sound information for an event. Other criteria may also be used to determine whether sound event information should be forwarded on to the lighting control processing system.

Upon establishing that a sound event meets all criteria, the original digitized and processed signal may be transmitted to the lighting control processing system 470. Alternatively or in addition, the sound characteristics determined for the sound event may be transmitted to the lighting control processing system 470. The lighting control processing system 470 includes a lighting control data processor 471 and an associated memory 473 and a switch controller 477. In some embodiments, the lighting control processing system 470 may include a wireless communication interface 475.

The lighting control data processor 471 is configured to receive sound event information from the acoustic signal processor 482 and compare it to criteria used to determine if one or more lighting elements 150 should be illuminated. Such criteria may be permanently stored in the memory 473 for retrieval by the data processor 471. In some embodiments, different criteria options may be made selectable by a user. In some embodiments criteria election may be made via the wireless communication interface 475. In other embodiments, a user interface (not shown) in the form of a keypad, witch or button panel may be used.

The lighting control data processor 471 may be further configured to, upon determining that illumination criteria have been met, identify an action to be taken in response. This can include an action for a specific lighting element 150 to be illuminated for a predetermined duration, an action for a random lighting element 150 to be illuminated for a predetermined duration, or for a sequence of one or more lighting elements 150 to be illuminated. Such actions may be accomplished by issuing switch commands to the switch controller 477. The switch controller 477 is configured to open and close a plurality of circuits 190, each of which connects a different illuminator assembly 152 to the power source 165. Upon receiving an illumination command from the lighting control data processor 471, the switch controller 477 closes the circuit for a specified illuminator assembly 477. Upon receiving a command to terminate illumination, the switch controller 477 opens the switch.

The lighting control data processor 471 may also be configured to control the illumination characteristics of lighting elements with variable lighting capability. For example, some illuminator assemblies 152 may have the capability of changing the color of emitted light. The lighting control data processor 471 may be configured to send commands to such illuminator assemblies 152 based on the occurrence of pre-programmed criteria or upon receiving instructions to do so.

In particular embodiments, the lighting control data processor 471 may be configured to compare the sound characteristics derived from received sound event data to expected sound characteristics for the resonant elements 120 of a wind-driven sound and light device 100. If the event sound characteristics match (within predetermined limits) expected sound characteristics for a particular one of the resonant elements 120, the lighting control data processor 471 may cause the particular lighting element 150 associated with that resonant element to be illuminated.

From the above, it can be seen that in wind chime devices according to the invention, the ringing of a particular resonant element can be used to initiate illumination of one or more lighting elements directly associated with that resonant element, Further, the response of the acoustic sensor and the speed of the processors used in the system 400 may be such that, to an observer, the illumination of the lighting element (or initiation of a lighting sequence) is nearly simultaneous with the sound of the ring. A sequence of sound events resulting from the sequential ringing of multiple resonant elements will produce a corresponding illumination sequence of the lighting elements associated with the resonant elements. It has been found, however, that to a typical observer, it may not matter that a specific lighting element associated with a particular chime is illuminated when that chime is struck so long as one of the lighting elements is illuminated. Accordingly, in some embodiments, any lighting element may be randomly selected for illumination upon occurrence of a sound event associated with the ringing of any of the resonant elements. This eliminates the need to analyze a sound event to determine which resonant element is the source of the event. This, in turn, reduces the processing required to analyze the event and increases the speed with which the system responds to the event.

As noted above, the lighting control processing system 470 may include a wireless communication interface 475 configured to allow wireless communication between the lighting control data processor 471 and a user's mobile device 10 or other data processor and/or a local or wide area communication network 20. This may be accomplished using any short-range wireless communication platform, such as near field communication (NFC), radio-frequency identification, and Bluetooth. In particular embodiments, the wireless communication interface 475 may be configured for communication over a network via a WIFI server. This may allow communication of instructions to the lighting control data processor 471 from any user computing device 10 usable to access the network 20. In such embodiments, a wind chime lighting application loaded into the memory of the user device 10 may be used to give a user operational control of the lighting functions of the device 100. For example, the wind chime lighting application may include options for the user to turn lighting functions on and off, change illumination criteria, or, change light colors (in embodiments where the lighting elements have variable color options). In some embodiments, the application may provide the user with the option of simply turning on all the lighting elements for steady illumination.

It can be seen that the lighting control data processor 471 may be programmed or otherwise configured to receive wind chime lighting application commands from a user device 10 via the network 20 and the wireless communication interface 475. The processor 471 may be further configured to respond by changing illumination operations and/or sending commands to the switch controller 477 and/or illuminator assemblies. Specific operational responses may be retrieved from the memory 473. These could include, for example, a response to an application command to turn on all lighting elements that includes causing the switch controller to close all illumination circuits and causing initiation of a timing function. Upon reaching a predetermined time interval, the processor 471 may cause the switch controller 477 to open all illumination circuits to turn off all the lighting elements.

The lighting control processor 471 may also be configured to initiate a predetermined lighting sequence upon command or upon occurrence of a particular sound event. Such a sequence could include turning the various illuminators on and off at varying or regular intervals over a period of time.

It will be understood that the data processing systems used in embodiments of the invention may execute one or more software applications to, for example, receive data, process received data, transmit data over a network, and receive data over a network. In some instances, data processing devices may use executable instructions stored on a processor-accessible medium. In addition or alternatively, a storage arrangement can be provided separately from the computer-accessible medium, which can provide the instructions to the processing arrangement so as to configure the processing arrangement to execute certain exemplary procedures, processes, and methods, as described herein. It will be understood that the depiction in FIG. 5 is an example only, and the functions and processes described herein may be performed by any number of interconnected processors. On the other hand, in some embodiments, the functions and processes described may be carried out in a single processor. It will also be understood that where the illustrated systems may have only a single instance of certain components, multiple instances of these components may be used. The illustrated systems may also include other devices not depicted in the drawings.

The illumination processing systems of the invention may be used in conjunction with any form of wind chime device having resonant elements that ring when struck and that have associated illumination devices. This may include, without limitation, single or multiple suspended chimes having solid or tubular resonant bodies, chimes having fixed bars or other resonant elements with wind blown strikers, and chimes or bells having internal strikers.

The sound sensing capability of the present invention provides a lighting system reliability that is not available to prior art wind chime devices that rely on electrical communication between the resonant element and the striker. In addition to the inherent problems with the approach, regular maintenance is required to assure that conductive contact surfaces remain clean and corrosion free. Using sensor-based lighting also allows the use of entirely non-conductive materials for the resonant elements and the strikers.

While the foregoing illustrates and describes exemplary embodiments of this invention, it is to be understood that the invention is not limited to the construction disclosed herein. The invention can be embodied in other specific forms without departing from the spirit or essential attributes.

What is claimed is:

1. A wind-driven sound and light device comprising:
at least one resonant element configured to produce a ringing sound when struck;
a striker configured and positioned to strike at least one of the at least one resonant element in response to ambient air motion, thereby producing a ringing event;
at least one lighting element comprising an illuminator, each of the at least one lighting element being associated with one of the at least one resonant element;
a power source;
a ring event sensor configured to produce and transmit a data signal in response to a ring effect produced by the ringing event; and
an illumination processing system in communication with the ring event sensor and a circuit arrangement comprising the power source and each of the at least one lighting element, the illumination processing system being configured to
receive the data signal from the ring event sensor, and
in response to the data signal, cause the circuit arrangement to activate the illuminator of at least one of the at least one lighting element by connecting it to the power source.

2. A wind-driven sound and light device according to claim 1 wherein the illumination processing system is further configured to cause the circuit arrangement to deactivate the illuminator of the at least one of the at least one lighting element by disconnecting it from the power source after expiration of a predetermined time interval.

3. A wind-driven sound and light device according to claim 1 wherein the ring effect is a sound wave and the ring event sensor is an acoustic sensor configured and positioned to receive and measure characteristics of the sound wave.

4. A wind-driven sound and light device according to claim 3 wherein each of the at least one resonant element produces a sound wave with different characteristics when struck by the striker.

5. A wind-driven sound and light device according to claim 4 wherein
the wind-driven sound and light device comprises a plurality of resonant elements, and
the illumination processing system is further configured to determine from the data signal which of the plurality of resonant elements produced the ring event and to cause the circuit arrangement to activate the illuminator of the lighting element associated with that resonant element.

6. A wind-driven sound and light device according to claim 1 wherein the ring effect is a structural vibration in the resonant element struck by the striker and the ring event sensor is a vibration sensor attached to the resonant element struck by the striker.

7. A wind-driven sound and light device according to claim 6 wherein
the wind-driven sound and light device comprises a plurality of resonant elements, each resonant element having a vibration sensor attached thereto, and
the illumination processing system is further configured to determine from the data signal which of the plurality of resonant elements produced the ring event and to cause the circuit arrangement to activate the illuminator of the lighting element associated with that resonant element.

8. A wind-driven sound and light device according to claim 1 wherein the ring effect is a structural vibration in the striker and the ring event sensor is a vibration sensor attached to the striker.

9. A wind-driven sound and light device according to claim 1 further comprising:
a suspension body comprising a housing having a housing wall defining an interior space in which the illumination processing system, the power source, and at least a portion of the circuit arrangement are disposed,
wherein each of the at least one resonant element is an annular tube suspended from the suspension body by a chime strand so that it hangs vertically lengthwise and is free to swing,
wherein the striker is suspended from the suspension body by a non-conductive main strand so that the striker is free to swing and rotate,
wherein each of the at least one lighting element is suspended from the suspension body by a lighting element strand so that the lighting element is free to swing, the lighting element strand comprising conductive wiring that passes through the housing wall and is connected at a first strand end to the circuit arrangement and at a second strand end to the illuminator of the lighting element.

10. A wind-driven sound and light device according to claim 1 wherein the illumination processing system is further configured to select the at least one of the at least one lighting element to be illuminated independent of the source of the ring event.

11. A wind-driven sound and light device comprising:
at least one resonant element configured to produce a ringing sound when struck;
a striker configured and positioned to strike at least one of the at least one resonant element in response to ambient air motion, thereby producing a ringing event;
at least one lighting element comprising an illuminator, each of the at least one lighting element being associated with one of the at least one resonant element;
a power source;
an acoustic sensor configured and positioned to receive sound waves produced by the ringing event, transform the soundwaves into an analog signal, and transmit the analog signal; and
an illumination processing system in communication with the acoustic sensor and a circuit arrangement comprising the power source and each of the at least one lighting element, the illumination processing system being configured to
receive the analog signal for the ringing event from the acoustic sensor,
convert the analog signal to a digital signal,
determine from the digital signal whether illumination criteria have been met, and
responsive to a determination that illumination criteria have been met, cause the circuit arrangement to activate the illuminator of at least one of the at least one lighting element by connecting it to the power source.

12. A wind-driven sound and light device according to claim 11 wherein the illumination processing system is further configured to cause the circuit arrangement to deactivate the illuminator of the at least one of the at least one lighting element by disconnecting it from the power source after expiration of a predetermined time interval.

13. A wind-driven sound and light device according to claim 11 wherein the illumination criteria are met by a determination that any of the at least one resonant element has been struck by the striker.

14. A wind-driven sound and light device according to claim 13 wherein the illumination processing system is configured to, upon a determination that the illumination criteria are met, randomly select one of the at least one lighting element and activate the illuminator of the selected lighting element by connecting it to the power source.

15. A wind-driven sound and light device according to claim 13 wherein
the wind-driven sound and light device comprises a plurality of resonant elements, the ringing sound of each resonant element having different sound characteristics, and
the illumination processing system is configured to
use the digital signal to determine sound characteristics for the ringing event,
compare the ringing event sound characteristics to the resonant element sound characteristics to identify a particular resonant element that produced the ringing event, and
connect the lighting element associated with the particular resonant element to the power source to power its illuminator.

16. A wind-driven sound and light device according to claim 11,
wherein the illumination processing system comprises a wireless communication interface configured for wireless communication via a network, and
wherein the illumination processing system is further configured to
receive user commands via the wireless communication interface.

17. A wind-driven sound and light device according to claim 16,
wherein the illumination processing system is further configured to
responsive to a first user command, cause the circuit arrangement to activate the illuminator of all or a subset of the lighting elements, and
responsive to a second user command, cause the circuit arrangement to deactivate all activated illuminators.

18. A wind-driven sound and light device according to claim 16,
wherein the illumination processing system is further configured to
responsive to a first user command, cause the circuit arrangement to sequentially activate and deactivate the illuminators of all or a subset of the lighting elements according to a predetermined pattern, and
responsive to a second user command, stop sequential activation and deactivation of the illuminators and cause the circuit arrangement to deactivate all activated illuminators.

19. A wind-driven sound and light device according to claim 11 further comprising:
a suspension body comprising a housing having a housing wall defining an interior space in which the illumination processing system, the power source, and at least a portion of the circuit arrangement are disposed,
wherein each of the at least one resonant element is an annular tube suspended from the suspension body by a chime strand so that it hangs vertically lengthwise and is free to swing,
wherein the striker is suspended from the suspension body by a non-conductive main strand so that the striker is free to swing and rotate,
wherein each of the at least one lighting element is suspended from the suspension body by a lighting element strand so that the lighting element is free to swing, the lighting element strand comprising conductive wiring that passes through the housing wall and is connected at a first strand end to the circuit arrangement and at a second strand end to the illuminator of the lighting element.

20. A wind-driven sound and light device according to claim 19,
wherein the acoustic sensor is a microphone at least partially disposed within the housing of the suspension body.

21. A wind-driven sound and light device according to claim 19,
wherein the lighting element strand of each lighting element passes through the annular tube of its associated resonant element so that the lighting element hangs beneath the associated resonant element.

22. A wind-driven sound and light device according to claim 19 further comprising
a generally planar sail body suspended from the suspension body by the main strand beneath the striker.

23. A wind-driven sound and light device comprising:
a suspension body comprising a housing having a housing wall defining an interior space;
a plurality of tubular chimes suspended vertically lengthwise from the suspension body by chime strands, each tubular chime being sized and configured to produce a ringing sound with different sound characteristics when struck;
a striker suspended from the suspension body by a non-conductive main strand, the striker being configured and positioned to strike one or more of the resonant elements as the result of a swinging motion produced by ambient air motion, each strike of a resonant element producing a ringing event;
a plurality of lighting elements, each lighting element being associated with one of the resonant elements and having an illuminator;
a power source disposed within the interior space;
an illumination circuit arrangement configured for selectively connecting each lighting element to the power source to activate the illuminator of each said lighting element;
an acoustic sensor configured and positioned to receive sound waves produced by ringing events, transform the soundwaves into analog signals, and transmit the analog signals;
an illumination processing system disposed within the interior space of the housing, the illumination processing system being in communication with the acoustic sensor and the circuit arrangement and being configured to receive and process signals received from the acoustic sensor and to cause the circuit arrangement to activate one or more illuminators in response to the processed signals.

24. A wind-driven sound and light device according to claim 23 wherein the illumination processing system is configured to cause the circuit arrangement to activate one or more illuminators only upon determining that the processed signals meet predetermined illumination criteria.

25. A wind-driven sound and light device according to claim 24 wherein the illumination processing system is further configured to
determine sound characteristics for each ringing event from the processed signals,
compare the ringing event sound characteristics to the sound characteristics of the tubular chimes to identify a particular tubular chime that produced the ringing event, and
cause the circuit arrangement to activate the illuminator of the lighting element associated with the particular tubular chime for a predetermined time interval.

26. A wind-driven sound and light device according to claim 24 wherein the illumination processing system is configured to
upon determining that illumination criteria are met by processed signals from a ringing event, select a random lighting element and cause the circuit arrangement to activate the illuminator of the randomly selected lighting element for a predetermined time interval.
